(19) United States
(12) Patent Application Publication
(10) Pub. No.: US 2004/0033376 A1
(43) Pub. Date: Feb. 19, 2004

(54) Thin-film layer, thin-film layer fabrication apparatus and thin-film device

(76) Inventor: Hiroshi Mori, Los Angeles, CA (US)

Correspondence Address: Gregory P. LaPointe, BACHMAN & LaPOINTE, P.C., Suite 1201, 900 Chapel Street, New Haven, CT, 06510-2802, US

(21) Appl. No.: 10/223,810

(22) Filed: Aug. 19, 2002

(51) Int. Cl. B32B 15/04

(52) U.S. Cl. 428/458; 428/457

(57) ABSTRACT

A thin-film layer with a cured layer formed on its surface wherein the thin film layer is formed by using a prepared solution and photo-initiated polymerization which results in aggregation within the prepared solution.

### BACKGROUND OF THE INVENTION

1. Field of the Invention

The present invention relates to a thin-film layer with a cured layer formed on its surface, a thin-film layer fabrication apparatus, and a thin-film device. Further, the invention relates to a thin-film layer formed by using a prepared solution and photo-initiated polymerization, which then results in aggregation within the prepared solution.

2. Prior Art and Its Drawback

There are known methods for curing a material such as a macromolecule or a polymer and the like, by simply irradiating the material with a UV light. However, the cured surface layer of the traditional method lacks the capability of creating a nearly pure, and homogenous surface, and furthermore, lacks sufficient resistance to chemical attack, wear and weather damage.

### SUMMARY OF THE INVENTION

The invention addresses the above drawback of the prior art and has the objective to achieve sufficient resistance to chemical attack, wear, and weather damage, which cannot be attained by the prior-art coating method of which resin is cured by UV or electron beam radiation.

The object of this invention is fulfilled by forming a molecular and/or particle assembly layer over a organic layer cured by UV or electron beam radiation.

The thin-film layer according to the invention comprises a transparent a molecular and/or particle assembly layer defining a cured surface layer over an organic layer, and is formed by coating a substrate with a polymer solution based on one resin selected from the group consisting of acrylic resins, urethane resins, epoxy resins and the like, and further applying, onto the polymer solution, a polymer/particle mixture solution containing therein at least one particle selected from the group consisting of metal particles, organic particles, inorganic particles, colloidal particles and the like and then followed by exposing the polymer/particle mixture solution to light or heat, thereby inducing a crosslinking polymerization reaction in the polymer/particle mixture solution over the polymer solution for gelating the particles.

The thin-film layer according to the invention comprises a transparent molecular and/or particle assembly layer defining a cured surface layer formed over the organic layer as a result of the exposure of the pre-polymer solution to light or heat inducing cross-linking polymerization reaction. A pre-polymer solution containing polymers, monomers, particles of the film layer and an initiator is first prepared in liquid state to allow a controlled photo-initiated polymerization.

Depending on the surface of the substrate, an initial base coat consisting of a polymer may have to be applied in order for the pre-polymer solution to create a strong cross-linking bond. This is usually not necessary for substrates that are synthetic polymers, such as film.

Once the pre-polymer solution has been applied, it is then cured with a UV light or electron beam. The irradiation will cause the photo-initiators in the pre-polymer solution to initiate an addition-polymerization reaction. This will result in the synthesis of graft copolymers with the original polymers and monomers, and induce a cross-linking polymerization reaction starting from the boundary of the substrate and pre-polymer, and result in a homogenous film layer remove on the top surface, which consists of the particle or element added to the pre-polymer solution. There are three factors that account to the reaction.

The addition-polymerization causes a decrease in volume of the pre-polymer solution due to solidification and cause the particles to diffuse to the surface, since there is no way to diffuse towards the substrate/pre-polymer border, which is cross-linked.

The polymer in their propagation stage helps to repel the particles to the surface using their charge.

An aggregation reaction occurs within the pre-polymer solution, which causes a separation of the graft copolymers, which have a hydrophobic characteristic, and the particles. The copolymers will continue to polymerize with the surface, and the remaining particles will move or collect at the top layer, which becomes the new film layer on the top because of its lighter mass.

The thin-film layer according to the invention comprises a transparent molecular and/or particle assembly layer defining a cured surface layer over an organic layer and is formed by coating a plastic substrate with a polymer/particle mixture solution containing therein at least one particle selected from the group consisting of metal particles, organic particles, inorganic particles, colloidal particles and the like and exposing the polymer/particle mixture solution to light or heat thereby inducing crossslinking polymerization reaction in the mixture for gelating the particles.

Where the substrate is metallic, it is preferred to electrodeposit the polymer on the substrate. The polymer/particle mixture solution is irradiated with UV light or electron beam, or otherwise heated. In the UV radiation, the polymer solution is exposed to UV light rays of different wavelengths.

The substrate is selected from the group consisting of metals, ceramics, glass, wood, paper, plastics and the like. The polymer is based on one resin selected from the group consisting of acrylic resins, urethane resins, epoxy resins and the like, and serves as a base coat.

The polymer/particle mixture solution contains a photo-polymerizable prepolymer, a photo-polymerizable monomer, a photo-polymerization initiator and, as required, a metal particle, organic particle, inorganic particle, colloidal particle or the like.

The molecular and/or particle assembly layer comprises a metal oxide, inorganic oxide or amorphous substance. Otherwise, the molecular and/or particle assembly layer may comprise SiO₂ or amorphous silica.

In a case where the above molecular and/or particle assembly layer comprises SiO₂ or amorphous silica, the thin-film layer is adapted to provide a transparent glass coating which is adequately applicable to metal articles such as road wheels of automobiles and the like.

When silica is chosen as the colloidal particle, a thin and homogenous thin film of a material similar to glass forms at the surface.

When two or more particles are included in the pre-polymer solution, the reaction will result in two film layers, such as a silica layer on top of a silver layer.

In the fabrication of a printed wiring board which currently requires the known techniques of electrolytic plating, electroless plating, lamination and the like, the molecular and/or particle assembly layer defining the top layer of the thin-film layer can be formed from a conductive metal such as copper or the like.

The molecular and/or particle assembly layer defining the top layer of the thin film layer can be also formed from a conductive metal such as copper or the like, which can be utilized to simplify fabrication of printed wiring boards from the complicated current techniques of electrolytic plating, electroless plating, lamination and the like. Therefore, it is possible to reconstruct discrete electrical components such as diodes, transistors, resistors, capacitors, semi-conductors, hybrid IC into a ‘thin film’ device, instead of the current form.

A thin-film layer fabrication apparatus for fabricating the thin-film layer according to the invention comprises: a chamber including a conveyor system for conveying a substrate, a coating applicator for applying, onto the substrate, a polymer solution based on one resin selected from the group consisting of acrylic resins, urethane resins, epoxy resins and the like, and a light/heat source for exposing a polymer/particle mixture solution to light or heat, the polymer/particle mixture solution comprising the polymer containing therein at least one particle selected from the group consisting of metal particles, organic particles, inorganic particles, colloidal particles and the like; and a filter for preventing the entrance of dusts and foreign substances into the chamber.

The light/heat source is a UV irradiation apparatus, electron beam irradiation apparatus or heat source. The UV irradiation apparatus emits UV light rays of different wavelengths. The fabrication system further comprises a UV lamp adjustable device for permitting a UV lamp of the UV irradiation apparatus to be inclined at a predetermined angle. The fabrication system further comprises a cooling system for cooling the UV irradiation apparatus.

### BRIEF DESCRIPTION OF THE DRAWINGS

FIG. 1A is a sectional view showing a multi-layered stack for forming a thin-film layer according to the first embodiment of the invention;

FIG. 1B is a sectional view showing the thin-film layer according to the first embodiment of the invention;

FIG. 2A is a sectional view showing a multi-layered stack for forming a thin-film layer according to a second embodiment of the invention;

FIG. 2B is a sectional view showing the thin-film layer according to the second embodiment of the invention;

FIG. 3A is a sectional view showing a multi-layered stack for forming a thin-film layer according to a third embodiment of the invention;

FIG. 3B is a sectional view showing the thin-film layer according to the third embodiment of the invention; and

FIG. 4 is a schematic diagram showing a thin-film layer fabrication apparatus according to the invention.

### DESCRIPTION OF THE PREFERRED EMBODIMENTS

Now, preferred embodiments of the invention will hereinbelow be described with reference to the accompanying drawings.

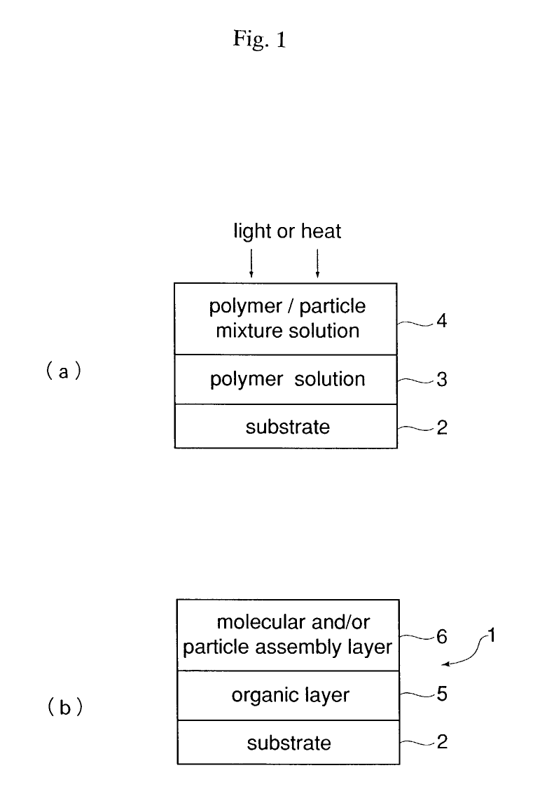

Referring to FIGS. 1A and 1B, a procedure of fabricating a thin-film layer 1 is described. First, a substrate 2 is prepared which is formed of one material selected from the group consisting of metals, ceramics, glass, wood, plastics, paper and the like. A polymer solution 3 based on one resin selected from the group consisting of acrylic resins, urethane resins, epoxy resins and the like is coated on the substrate 2. The polymer solution serves as a base coat layer.

A polymer/particle mixture solution 4 comprising a polymer solution 3 containing at least one particle material selected from the group consisting of metal particles, organic particles, inorganic particles, colloidal particles and the like is coated on the base coat layer. Then, the polymer/particle mixture solution 4 over the polymer solution 3 is irradiated with light or heated. This forming process induces crosslinking polymerization reaction in the polymer/particle mixture solution over the polymer solution, so that the particles are gelated to form a transparent molecular and/or particle assembly layer 6 over the organic layer 5. The organic layer 5 comprises a polymer and polymer/particle mixture. The molecular and/or particle assembly layer 6 serve as a cured surface layer.

Where the above embodiment employs a substrate formed of a metal, the polymer solution as the base coat may preferably be coated over the substrate by electrodeposition. The polymer/particle mixture solution may preferably be irradiated with UV light rays or electron beams from all directions or heated. In the UV radiation, UV rays of different wavelengths are applied.

Now, the following is a description on a case where the substrate 2 is of an aluminum alloy and the molecular assembly layer or particle assembly layer 6 is formed at the uppermost layer. The polymer solution 3 forming the base coat layer is electrodeposited on the substrate 2 of aluminum alloy in thickness of about 15 to 20 μm. The polymer solution 3 is cured by heating in an oven. Next, the polymer/particle mixture solution 4 is coated on the base coat layer. The polymer/particle mixture solution 4 is then exposed to UV rays. This process induces crosslinking polymerization reaction between the polymer solution and the polymer/particle mixture solution.

Specifically, the UV radiation activates a photoinitiator in the material and then affects a prepolymer and a monomer for effecting a polymerization propagation reaction followed by a chain transfer reaction and termination of the crosslinking polymerization. At the start of the propagation reaction, the photoinitiator scattered around colloidal silica and the prepolymer and monomer present in the vicinity thereof are partially cured and polymerized to form local assemblies, which propagates across the layer to terminate the crosslinking polymerization.

A crosslinking polymerization reaction occurs near an interface between the polymer solution as the base coat layer and the polymer/particle mixture solution. Before the scattered local molecular assemblies propagate across the layer to terminate the crosslinking polymerization reaction, the crosslinking polymerization starts from the interface to form a cured assembly. Thus, the molecules continue the crossllinking polymerization reaction driving away foreign substances and mixture substances, thereby pushing up silica, for example, to a layer over the organic material to form a cured surface layer.

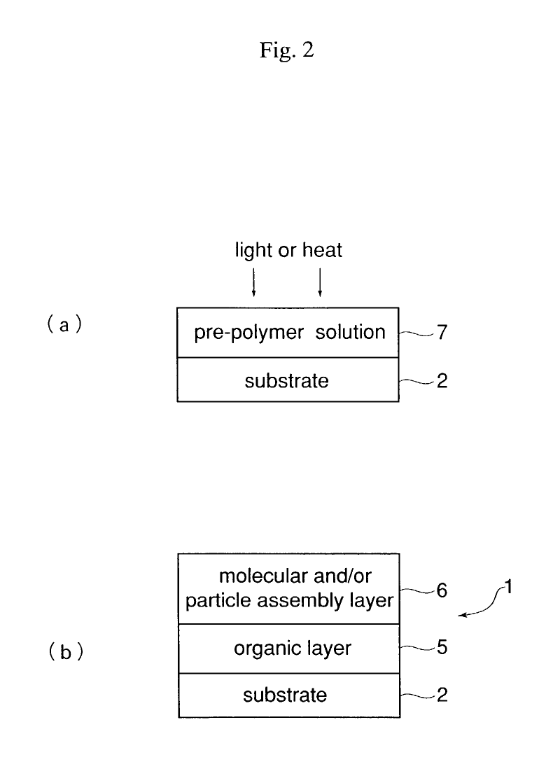

Referring to FIGS. 2A and 2B, the substrate 2 comprises one material selected from the group consisting of metals, ceramics, glass, wood, paper and the like. An organic layer 5 of a polymer and a polymer/particle mixture is formed by coating the substrate 2 with pre-polymer solution 7 containing polymers, monomers, particles and an initiator. A transparent molecular and/or particle assembly layer 6 defining a cured surface layer is also formed over the organic layer 5 as a result of the exposure of the pre-polymer solution 7 to light or heat inducing crosslinking polymerization reaction.

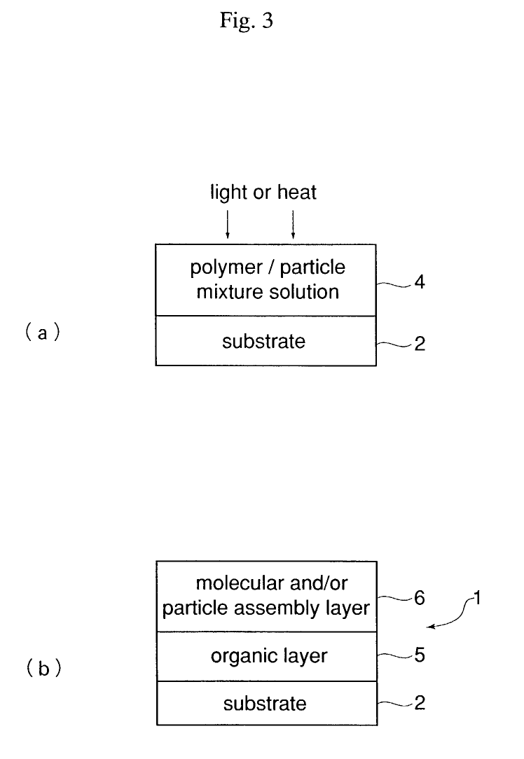

Referring to FIGS. 3A and 3B, procedure of fabricating a thin-film layer is described. This thin-film layer differs from that of FIG. 1 in that a plastic substrate 2 is used so as to dispense with the polymer as the base coat. Therefore, the polymer/particle mixture solution 4 is directly coated on the substrate 2. Subsequently, the polymer/particle mixture solution 4 are irradiated with UV light. The process induces the crosslinking polymerization reaction in the polymer/particle mixture solution 4. Thus, a transparent molecular and/or particle assembly layer 6 is formed over the organic layer 5.

The molecular and/or particle assembly 6 layer comprises a transparent metal oxide, inorganic oxide or amorphous substance. Alternatively, the molecular and/or particle assembly layer comprises SiO₂+C or amorphous silicon. The SiO₂+C layer has a thickness of about 5 μm.

It is also possible to produce in the organic layer 5 a thin-film electronic part, such as thin-film devices including ICs, hybrid ICs and the like; condensers; capacitors; resistors and the like, by exposing the polymer/particle mixture solution to controlled UV rays or electron beams and subjecting the same to a lithographical step in combination.

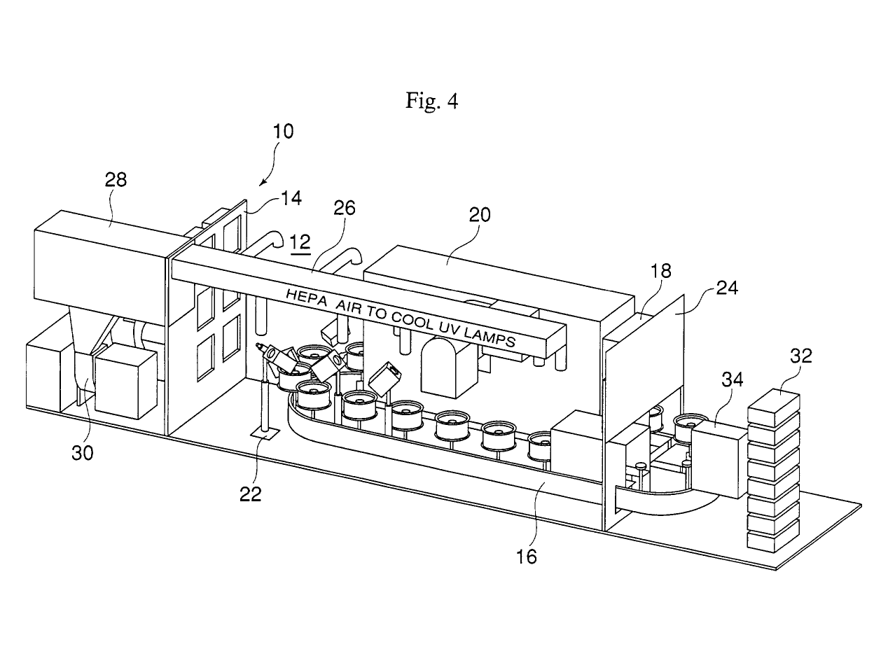

FIG. 4 schematically shows a fabrication apparatus for fabricating the thin-film layer. Referring to the figure, the thin-film layer fabrication apparatus 10 comprises a chamber 12 and a filter 14 for preventing the entrance of dusts and foreign substances into the chamber. The chamber 12 includes a conveyor system 16 for conveying the substrates; a coating applicator 18 for coating each substrate with a polymer solution as a base coat layer which is based on at least one resin selected from the group consisting of acrylic resins, urethane resins and epoxy resins, and then applying, onto each base coat layer, a polymer/particle mixture solution comprising a polymer solution containing therein at least one particle selected from the group consisting of metal particles, organic particles, inorganic particles, colloidal particles and the like; a heating chamber 20 for heat curing the polymer solution thus applied; and a light/heat source 22 for exposing the polymer/particle mixture solution over the base coat layer to light rays of different wavelengths or heat from all directions, the polymer/particle mixture solution containing therein at least one particle selected from the group consisting of metal particles, organic particles, inorganic particles, colloidal particles and the like.

The chamber is enclosed by divider walls 24 except for a place where the filter 14 is installed. The light/heat source 22 may be a UV irradiation apparatus, electron beam irradiation apparatus or heating apparatus. The UV irradiation apparatus emits UV light rays of different wavelengths. The fabrication system may further comprise a UV lamp adjustable device for permitting UV lamps of the UV irradiation apparatus to be inclined at predetermined angles. The fabrication system may further comprise a cooling system 26 which is disposed at a position above the UV irradiation apparatus 22 for air cooling the same. The cooling system 26 includes a filter 28 for cooling air and a cooling blower 30 for discharging the cooling air, which are disposed outside of the chamber. The chamber may be further provided with an inert gas supply for introducing an inert gas thereinto.

1. A thin-film layer comprising:
a substrate comprising one material selected from the group consisting of metals, ceramics, glass, wood, paper and the like;
an organic layer of a polymer and a polymer/particle mixture formed by coating the substrate with the polymer solution based on one resin selected from the group consisting of acrylic resins, urethane resins, epoxy resins and the like, and further applying, onto the polymer solution, the polymer/particle mixture solution containing therein at least one particle material selected from the group consisting of metal particles, organic particles, inorganic particles, colloidal particles and the like, followed by exposing the polymer/particle mixture solution to light or heat; and
a transparent molecular and/or particle assembly layer defining a cured surface layer formed over the organic layer as a result of the exposure of the polymer/particle mixture solution to light or heat inducing crosslinking polymerization reaction in the polymer/particle mixture solution over the polymer solution for gelating the particles.

2. A thin-film layer comprising:
a substrate comprising one material selected from the group consisting of metals, ceramics, glass, wood, paper and the like;
an organic layer of a polymer and a polymer/particle mixture formed by coating the substrate with a pre-polymer solution containing polymers, monomers, particles and an initiator; and
a transparent molecular and/or particle assembly layer defining a cured surface layer formed over the organic layer as a result of the exposure of the pre-polymer solution to light or heat inducing cross-linking polymerization reaction.

3. A thin-film layer comprising:
a plastic substrate;
an organic layer of a polymer and a polymer/particle mixture formed by coating the substrate with polymer/particle mixture solution applied over the substrate, the mixture solution containing therein at least one particle selected from the group consisting of metal particles, organic particles, inorganic particles, colloidal particles and the like; and
a transparent molecular and/or particle assembly layer defining a cured surface layer formed over an organic layer as a result of the exposure of the polymer/particle mixture solution to light or heat inducing crosslinking polymerization reaction in the mixture for gelating the particles.

4. A thin-film layer according to claims 2 or 3, wherein the light is UV light or electron beam.

5. A thin-film layer according to claim 4, formed by irradiation with UV light rays of different wavelengths.

6. A thin-film layer according to claim 2 or 3, wherein the polymer solution is electrodeposited on the substrate.

7. A thin-film layer according to claim 2 or 3, wherein the molecular and/or particle assembly layer comprises a metal oxide, inorganic oxide or amorphous substance.

8. A thin-film layer according to claim 7, wherein the molecular and/or particle assembly layer comprises SiO₂ or amorphous silicon.

9. A thin-film device comprising the thin-film layer according to claim 1, 2 or 3.

10. A thin-film layer fabrication apparatus comprising:
a chamber including a conveyor system for conveying a substrate,
a coating applicator for applying, onto the substrate, a polymer solution based on one resin selected from the group consisting of acrylic resins, urethane resins, epoxy resins and the like, and
a light/heat source for exposing a polymer/particle mixture solution to light or heat, the polymer/particle mixture solution comprising the polymer containing therein at least one particle selected from the group consisting of metal particles, organic particles, inorganic particles, colloidal particles and the like; and
a filter for preventing the entrance of dusts and foreign substances into the chamber.

11. A thin-film layer fabrication apparatus according to claim 10, wherein the light/heat source is a UV irradiation apparatus, electron beam irradiation apparatus or heat source.

12. A thin-film layer fabrication apparatus according to claim 11, wherein the UV irradiation apparatus emits UV light rays of different wavelengths.

13. A thin-film layer fabrication apparatus according to claim 12, further comprising an adjustable UV lamp device for permitting a UV lamp of the UV irradiation apparatus to be inclined at a predetermined angle.

14. A thin-film layer fabrication apparatus according to claim 10, further comprising a cooling system for cooling the UV irradiation apparatus.

15. A thin-film layer fabrication apparatus according to claim 10, further comprising an inert gas supply for introducing an inert gas into the chamber.
